(19) United States
(12) Patent Application Publication
(10) Pub. No.: US 2005/0135272 A1
(43) Pub. Date: Jun. 23, 2005

(54) Method for setting up a logical connection between non-adjacent initial and final nodes in a telecommunications network

(75) Inventors: Martin Vigoureux, Paris (FR); Emmanuel Dotaro, Verrieres Le Buisson (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/012,206

(22) Filed: Dec. 16, 2004

(30) Foreign Application Priority Data
Dec. 19, 2003 (FR) 03 14 981

(51) Int. Cl. H04L 12/28

(52) U.S. Cl. 370/254; 370/351

(57) ABSTRACT

This invention relates to a Method for setting up a logical connection between non-adjacent initial node (Ni) and final node (Nf) in a telecommunications network (T), the method comprising determination of a spatial route (ROUTE1) comprising at least a so-called transit node (N1, N4, N6, N9) intermediate between the final node and the initial node and a sequence of route segments connecting the nodes in pairs, the initial node sends a reservation query (RQ1) associated with the spatial route, the query containing values of parameters characteristic of the connection and passing through at least the first transit node (N1) of the spatial route and with the final node as the final destination. The method also comprises an automatic calculation by a transit node, called a decisional node (N4, N9) based on local information, the said calculation result (c4, sp4, sp9) possibly being capable of modifying at least one of the said values of the connection parameters.

The invention relates to a method for setting up a logical connection between non-adjacent initial and final nodes in a telecommunications network.

A telecommunications network is conventionally composed of a set of nodes connected in pairs through links.

In circuit switching or connection oriented networks, a connection needs to be setup between the initial node and the final node in order to transfer customer data (voice, video, etc.).

A connection is setup by means of a software type network control plan based on a representation of the network.

The method for setting up the connection is broken down into two phases in a known manner, as follows:
a routing phase, in other words determination of a spatial route connecting the initial node and the final node, the spatial route comprising several so-called transit nodes intermediate between the final node and the initial node and therefore a sequence of route segments connecting the nodes in pairs,
a signaling phase that includes the following steps in sequence:
   the initial node sends a reservation query associated with the spatial route, the query containing values of parameters characteristic of the connection, passing through all predefined transit nodes that will thus temporarily store the reservation query,
   the final node receives the query, possibly added to along the route,
   the final node makes a decision about the reservations made and sends a validation return message for these reservations, which follows the spatial route in the reverse direction until reaching the initial node.

However, when a node observes that it cannot satisfy the criteria to setup the connection, this node will send an error message backwards and the complete search procedure will be restarted.

Furthermore, the query contains information, for example about the spatial route, the connection type or pass band needs for each transit node.

This query may become very large as it progresses, particularly when it contains information necessary for calculating one or several spectral routes.

In the case of a network composed of nodes with optical switching by wavelength, not only does the spatial route have to be determined, but a spectral route is also necessary since each spatial route segment may support several wavelengths each forming a spectral route segment. Choosing a spectral route thus consists of choosing the wavelength, wavelengths, wavelength band or wavelength bands to be used in sequence on the different segments along the spatial route.

The spectral route is usually chosen by the final node using information contained in the query.

A large quantity of information also needs to be managed in the signaling phase (availability, wavelength continuity, etc.) to set up the connection correctly.

There may be also connection capacity constraints or service quality constraints that influence the final choice of the spectral route.

The purpose of the invention is to propose a reliable and fast signaling phase within a method for setting up a logical connection between non-adjacent initial and final nodes in an optical and/or electrical switching telecommunications network.

To achieve this, the invention proposes a process including the following steps in sequence:
determination of a spatial route connecting the initial and final nodes, the spatial route comprising at least one so-called transit node inserted between the initial and final nodes and a sequence of route segments connecting the said nodes in pairs,
the initial node sends a reservation query associated with the spatial route, the query containing values of parameters characteristic of the connection, transiting at least through the first transit node of the spatial route and with the final node as the final destination,
characterized in that it also comprises the following step:
an automatic calculation by a transit node called a decisional node based on local information, the calculation result possibly modifying at least one of the said values of the connection parameters.

The automatic calculation may be done by one or several successive decisional nodes on the spatial route. Each calculation takes account of local information, in other words information not distributed in the network and usually more recent and complete.

The process gives priority to the execution of an intermediate calculation, rather than systematically sending an error return message when it seems impossible to setup a connection. The decisional node(s) has (have) authority to modify connection parameters in order to increase the probability of the connection being setup successfully.

For example, the resource(s) to be reserved are as followed in increasing order of granularity: a level 2 layer, an SDH (Synchronous Digital Hierarchy) type block, or a SONET (Synchronous Optical NETwork) type block, a wavelength, a wavelength band, an optical fiber, and more generally the passband.

In one embodiment, the method includes processing of the query by a decisional node, using the said calculation.

Each query processing may consist of implementation of the calculation result and preferably involve a summary of the values of connection parameters, for example to reduce the message size and/or to simplify calculations made by the final node.

By synthesizing values of parameters characteristic of the connection such as spectral information, each calculation will also simplify the final global processing done by the final node and also reduce calculation times.

The choice of the decisional node(s) may be made during determination of the spatial route or by self-determination.

The calculation may be made based on local information in relation with at least one of the following criteria: the maximum transmittable query size, the availability of resource sharing, the local policy provided by a network management plan, a failure, network protection, service quality (management of priority connections and/or priority traffic).

Thus, the decisional node is capable of modifying the query as a function of events.

The calculation result may involve a modification of segments along the spatial route starting from the decisional node.

For example, a modification is made between two adjacent decisional nodes (separated or not separated by simple transit nodes), or between the last decisional node and the final node.

As an example, the modification may be a replacement of one or several transit nodes by one or several other nodes in the network.

Furthermore, it is sometimes necessary to perform operations on the carrier signal carrying data useful to be transmitted and/or the data themselves, requiring the use of special equipment in the network.

These operations may concern regeneration and/or wavelength conversion and may be done by purely optical means or by optical-electrical conversion means and electrical-optical conversion means.

The term <<wavelength continuity>> is used when the same wavelength is used from the initial node to the final node, even if operations on the data carrier signal and/or transported data require optical-electronic-optical conversions, or 1R, or 2R, 3R regenerations.

The term <<transparency>> is used, making a distinction between several types of transparency, depending on whether we want to avoid optical-electronic-optical conversions, or wavelength conversions, or 1R, or 2R, 3R regenerations or a combination of these operations.

In a network that is at least partially transparent (for example an all optical or hybrid network, and not an opaque network), each segment along the spatial route may be capable of carrying several wavelengths, each of which forms a spectral route segment.

The method may then preferably include a step to determine candidate spectral route(s) for the spatial route (possibly modified) including:
determination from the calculation in at least one so-called decisional processing node, of at least one spectral route between the decisional processing node and a previous decisional node along the route or possibly the initial node.

Therefore, every spectral route is calculated for two adjacent decisional processing nodes (separated or not separated by one or more transit nodes) or between the initial node and the first decisional processing node (separated or not separated by one or more transit nodes). The spectral path may be subdivided into spectral segments.

Each spectral path may be defined with a large degree of freedom, for example there is no need to choose all wavelengths previously proposed for a spectral path on the upstream side.

Thus, the spectral route is not fully calculated by the final node that uses the information calculated in advance by decisional nodes.

In a first embodiment, each decisional node is a decisional processing node and the process also comprises:
possibly, the addition of information about the connection collected in at least one transit node, into the said query,
send a return message, preferably by the final node, so as to validate the wavelength reservation, the said message reaching the last decisional node, and indicating the necessary configuration for the last spectral path located between the last decisional node and the said final node,
if necessary, selection by the last decisional node, of the best spectral path among the set of determined candidate spectral paths,
the last decisional node sending the said return message so as to validate the wavelength reservation, the message being completed by also indicating the configuration necessary for the said best spectral path and reaching the last but one decisional node or possibly the initial node,
if applicable, the addition of steps similar to the previous two steps for each remaining decisional node, until the reservation of wavelength(s) is validated in the initial node.

In a second embodiment, the step to determine the candidate spectral routes also includes:
addition of information related to the said determined spectral path(s) into the query, by the said at least one decisional processing node,
selection by the said final node, of the best spectral paths among the spectral paths proposed by the said at least one decisional processing node,
the final node sends a return message so as to validate the reservation of wavelength(s), as far as the initial node.

Advantageously, this return message contains appropriate information for configuration of each decisional node and for configuration of the transit node(s), if any, modified if necessary.

The invention will be better understood and other characteristics will become clear after reading the following description and accompanying figures:

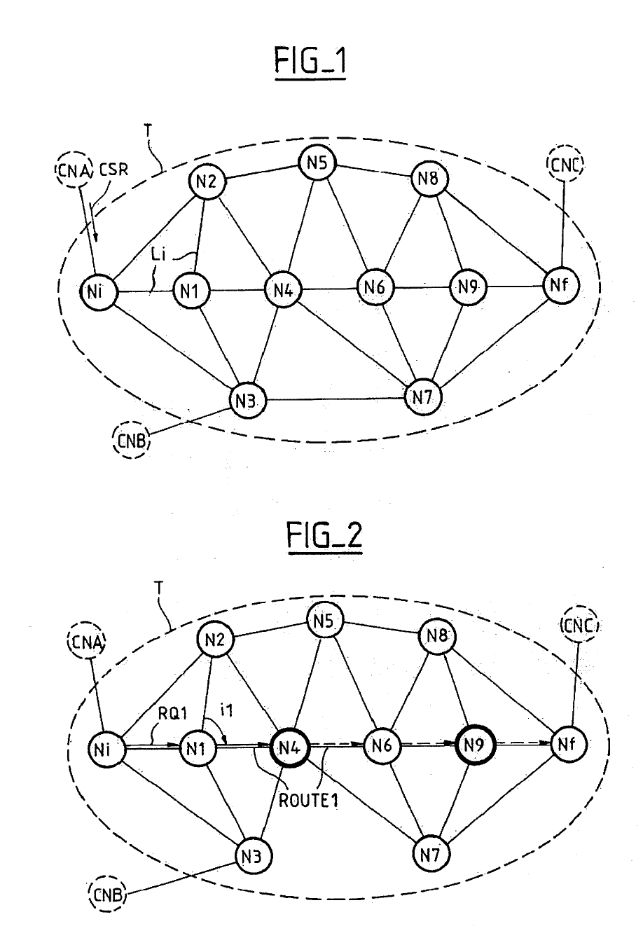

FIG. 1 shows an example of a telecommunications network in which the method according to the invention can be used,

FIGS. 2 to 5 illustrate a first embodiment of the method according to the invention, in the example network shown in FIG. 1,

FIG. 6 shows a second embodiment of the method according to the invention, in the example network shown in FIG. 1.

The example of a T network shown in FIG. 1 includes nodes Ni, N1 to N9, Nf with optical switching, for example by wavelengths (wavelength bands), and interconnected in pairs through two-directional links Li.

Each link Li preferably comprises several optical fibers, each of these optical fibers possibly containing several wavelengths grouped into one or several bands. For example, one link may contain five available wavelengths.

In this example, the T network can interconnect three customer networks CNA, CNB, CNC that are connected to nodes N1, N3, Nf respectively at the periphery of the T network. The method according to the invention is implemented in the T network and is completely independent of the number and nature of these customer networks.

For example, a query to setup a CSR connection is sent through the customer network CNA to the node Ni in order to setup a connection between customer networks CNA and CNC.

Node Ni is referred to as the initial node, and node Nf is referred to as the final node, to facilitate the description of how this connection is setup.

The query CSR contains the identity of the querying customer network CNA and the queried customer network CNC, and for example mentions transparency, capacity, service quality constraints, etc.

The network T must preferably determine a transparent route, and if this is not possible, a route containing the least possible number of non-transparent points while respecting capacity and service-quality constraints fixed for this connection.

Constraints on optical transparency parameters may include values of the wavelength, spectral spacing, and also tolerance on non-linearity effects (mix of four waves, etc.), obligation for lack of regeneration, etc.

FIG. 2 illustrates a first embodiment of the method for setting up a connection, which is applied to the above mentioned connection.

When the connection setup query is received, the network T translates constraints mentioned in the connection query to constraints related to routing.

The network T conventionally comprises a management plan and a transport plan. Software means for the OSPF-TE (Open Short Path First-Traffic Engineering) protocol defined by the IETF (Internet Engineering Task Force) are implemented in each node Ni, Nf, N1 to N9.

The management plan for network T determines a spatial route connecting the customer network CNA to the customer network CNC that includes initial and final nodes, transit nodes and links, otherwise qualified as route segments, as a function of the topology and connectivity of the network T.

FIG. 2 shows the spatial route ROUTE1 that optimally satisfies all routing constraints mentioned in the initial connection CSR setup query:

The route ROUTE1 comprises so-called transit nodes N1, N4, N6, N9 between the initial node Ni, and the final node Nf.

The initial node Ni selects one or several transit nodes and authorizes them to make a decision related to setting up the connection if necessary, based on information local to these nodes.

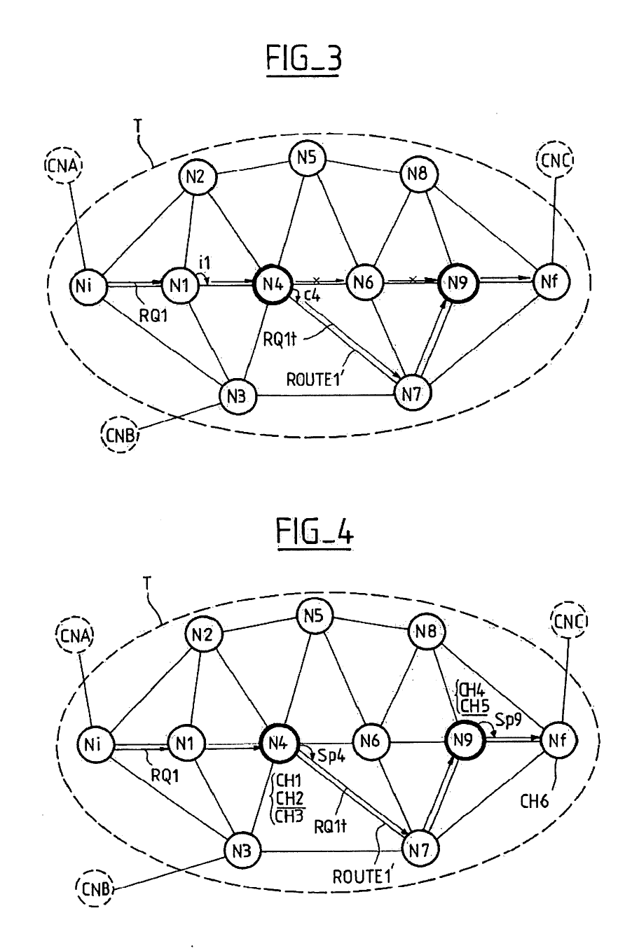

The selected nodes N4, N9 qualified as decision making nodes (symbolized by a thick line on FIGS. 3 to 5) include automatic calculation means that are activated, unlike similar means possibly present in other transit nodes.

In one variant, decisional nodes are capable of self-determination since, for example, an excessively voluminous query can make a decision necessary.

The initial node Ni then sends a reservation query RQ1 addressed to the final node Nf and normally routed on the spatial route ROUTE1.

This query contains values of parameters characteristic of the connection such as the required pass band, data encoding, the switching type, the protection level, the protection type, the initial node, the final node, the priority and the reservation type.

The routing along this route ROUTE1 is controlled by the initial node Ni, for example by supplying the query RQ1 to signaling means of the network T.

Any node through which the reservation query RQ1 passes can add values of parameters concerning the route segment immediately on the upstream and/or downstream side of this node on this spatial route, or parameters concerning interfaces of this node, to the contents of this query. For example, node N1 adds spectral information i1 giving the number of usable wavelengths.

Query RQ1, passes firstly through node N1 that will temporarily store the resource reservation instruction, and is then received by the first decisional node N4.

The first decisional node N4 may for example be aware of a failure such as a break in the fiber(s) between itself N4 and node N6. This first decisional node N4 makes an automatic calculation as quickly as possible to compensate for this failure, so that it remains possible to set up the connection.

Thus, the result of the calculation c4 modifies the route ROUTE1.

As shown in FIG. 3, this node N4 decides to replace the transit node N6 by a new transit node N7 (and spatial route segments between nodes N4 and N6 and between nodes N6 and N9), by new spatial route segments between nodes N4 and N7 and between nodes N7 and N9.

The information c4 resulting from this calculation, in other words information indicating the modification of the spatial route ROUTE1, is input into the reservation query RQ1 to replace initial routing information that is null and void. The processed query RQ1t is transmitted along the modified route ROUTE 1′. Furthermore, the first decisional node N4 is also capable of automatically calculating one and preferably several upstream spectral paths, taking account of local spectral information for example on transparency or pass band availabilities.

For example, this calculation can be triggered if the decisional node N4 observes that spectral information i1 collected along the upstream node N1 makes the query RQ1 excessively voluminous or if this decisional node N4 forms an opaque point in the network T.

Therefore, when using previously collected spectral information i1 in particular, the first decisional node N4 is capable of making an automatic calculation, for example to determine three possible spectral routes CH1 to CH3 between the initial node Na and itself, a spectral path possibly being subdivided into several spectral segments. Therefore the spectral information sp4 resulting from this calculation is also introduced into the processed query RQ1t to replace all spectral information i1. This simplifies determination of the spectral route.

Similarly, the second decisional node N9 is capable of for example calculating two possible spectral routes CH4, CH5 between the first decisional node N4 and itself. The spectral information sp9 related to these paths is also introduced into the processed query RQ1t.

On reception of the processed reservation query RQ1t, the final node Nf will simply calculate the best last spectral path CH6 supported by the modified spatial route ROUTE1′ and located between the second decisional node N9 and itself.

The final node Nf also selects the best spectral paths among the spectral paths CH1 to CH5 proposed by the decisional nodes N4, N9. For example, it selects spectral paths CH2 and CH5 (symbolized by an underlined reference in FIG. 4).

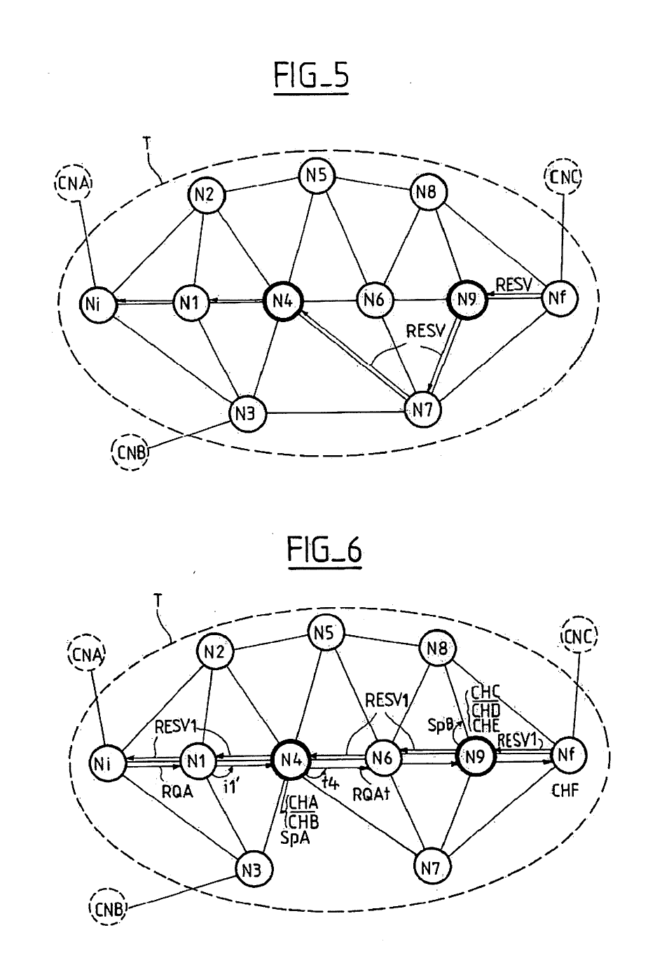

As shown in FIG. 5, the final node Nf then sends a return message RESV so as to validate reservation of wavelength(s) along the entire modified route ROUTE1′.

The return message RESV contains information appropriate for configuration of decisional nodes N4, N9 as soon as it is sent, and also contains information for configuration of new transit nodes N7, N1 and of the initial node Ni.

FIG. 6 illustrates a second embodiment of the process for setting up a connection, which is applied to the above mentioned connection.

Only steps that are distinct from the first embodiment are described in detail.

Elements common to the two embodiments have the same references.

When the connection setup query is received, the network T translates constraints mentioned in the connection query to constraints related to routing.

A spatial route ROUTE1 is determined in the same way as for the first node.

The choice of decision making nodes is made only by self-determination of the transit nodes, for example based on local information. For example, node N1 passed through adds information i1′ to the reservation query RQA and when this query reaches the transit node N4, this transit node observes that this query is too voluminous compared with the maximum transmittable size or with a fixed predetermined limiting size and decides to process the query itself. Node N4 then makes a calculation t4 to modify and synthesize one or more values of connection parameters, for example by eliminating spectral information.

While the query RQAt thus compressed continues along the route ROUTE1, node N4 uses all spectral information initially present in the query RQA and local information to make a new automatic calculation spA to determine possible spectral paths between the initial node Ni and itself, for example two paths CHA, CHB. This intermediate calculation spA justifies elimination of superfluous spectral information in the query RQAt.

Another node N9 can also independently decide to make a calculation spB of the possible spectral paths between the decisional node N4 and itself, for example three paths CHC, CHD, CHE.

On reception of the reservation query RQAt, the final node Nf will determine only the last spectral path CHF between itself and the last decisional node N9 performing a calculation of spectral paths.

The final node Nf then sends a return message RESV1 addressed to this last decisional node N9 to validate reservation of the wavelength(s) in this route segment. This first message RESV1 indicates the configuration necessary for the last spectral path CHF, to this last decisional node N9.

The last decisional node N9 then selects the best spectral path, for example CHC (symbolized by a reference underlined in FIG. 6) among those that it has already calculated CHC to CHE. It then sends the validation return message RESV1 that it has completed in order to enable the configuration of nodes N6, N4 passed through, and that arrives in the first decisional node N4.

Similarly, after reception of the completed validation return message RESV, the first decisional node N4 selects the best spectral path, for example CHA (symbolized by an underlined reference in FIG. 6), among those that it has already calculated CHA, CHB. It then sends the validation return message RESV once again completed to enable configuration of nodes N1, Ni passed through, and this message arrives in the initial node Ni.

In the method described above, instead of sending return error messages through a transit node when it is apparently impossible to setup the connection, connection parameters will be corrected to make it possible.

1. Method for setting up a logical connection between non-adjacent initial node (Ni) and final node (Nf) in a telecommunications network (T), the method comprising the following steps in sequence:
determination of a spatial route (ROUTE1) connecting the initial node and the final node, the spatial route comprising at least a so-called transit node (N1, N4, N6, N9) intermediate between the final node and the initial node and therefore a sequence of route segments connecting the nodes in pairs,
the initial node sends a reservation query (RQ1, RQA) associated with the spatial route, the query containing values of parameters characteristic of the connection, passing through at least the first transit node (N1) of the spatial route and with the final node as the final destination,
characterised in that it also comprises the following step:
an automatic calculation by a transit node called a decisional node (N4, N9) based on local information, the calculation result (c4, sp4, sp9, t4, spA, spB) possibly being capable of modifying at least one of the said values of the connection parameters.

2. Method for setting up a logical connection according to claim 1 characterised in that it includes processing of the query (RQ1, RQ1t, RQA) by a decisional node (N4, N9) using the said calculation (c4, sp4, sp9, t4).

3. Method for setting up a logical connection according to claim 2 characterised in that processing of the query (RQ1, RQ1t) consists of implementation of the calculation result (c4, sp4, sp9) and preferably involves a summary of the values of connection parameters.

4. Method for setting up a logical connection according to claim 1 characterised in that the choice of the decisional node(s) (N4, N9) is made during determination of the spatial route (ROUTE 1) or by self-determination.

5. Method for setting up a logical connection according to claim 1 characterised in that calculation (c4, sp4, sp9, t4, spA, spB) is done based on local information in relation with at least one of the following criteria: the maximum transmittable query size, the availability of resource sharing, the local policy provided by a network management plan, a failure, network protection, service quality.

6. Method for setting up a logical connection according to claim 1 characterised in that the calculation result (c4) involves a modification of segments along the spatial route (ROUTE1) starting from the decisional node (N4).

7. Method for setting up a logical connection according to claim 1 characterised in that each segment along the spatial route is capable of carrying several wavelengths, each of which forms a spectral route segment, the method includes a step to determine candidate spectral route(s) for the said spatial route possibly modified (ROUTE1, ROUTE 1′) including:
determination from the said calculation (sp4, sp9, spA, spB) in at least one so-called decisional processing node (N4, N9), of at least one spectral route (CH1 to CH5, CHA to CHE) between the decisional processing node and a previous decisional node (N4) along the route or possibly the initial node (Ni).

8. Method for setting up a logical connection according to claim 7 characterised in that each decisional node (N4, N9) is a decisional processing node, and in that the process also comprises:
possibly, the addition of information (i1′) about the connection collected in at least one transit node (N1), into the reservation query (RQA),
send a return message (RESV1) so as to validate the wavelength(s) reservation, the said message reaching the last decisional node (N9) and indicating the necessary configuration for the last spectral path (CHF) located between the last decisional node and the said final node (Nf),
if necessary, selection by the last decisional node (N9) of the best spectral path (CHC) among the set of determined candidate spectral paths (CHC to CHE),
the last decisional node (N9), sending the said return message (RESV2) so as to validate the wavelength(s) reservation, the message being completed by also indicating the configuration necessary for the said best spectral path (CHC) and reaching the last but one decisional node (N4) or, possibly, the initial node,
if applicable, the addition of steps similar to the previous two steps for each of the remaining decisional nodes (N4) until the reservation of wavelength(s) is validated in the initial node (Ni).

9. Method for setting up a logical connection according to claim 7 characterised in that it includes:
addition of information (sp4, sp9) related to the said determined spectral path(s) (CH1 to CH5) into the reservation query (RQ1t) by the said at least one decisional processing node (N4, N9),
selection by the said final node (Nf) of the best spectral paths among the spectral paths (CH2, CH5) proposed by the said at least one decisional processing node,
the said final node (Nf) sends a return message (RESV) so as to validate the reservation of wavelength(s), as far as the initial node (Ni).

10. Method for setting up a logical connection according to claim 9 characterised in that the return message contains appropriate information for configuration of each decisional node (N4, N9) and also contains information for configuration of the transit node(s), if any, modified if necessary (N1, N7).
